(19) United States
(12) Patent Application Publication
(10) Pub. No.: US 2004/0146697 A1
(43) Pub. Date: Jul. 29, 2004

(54) Optically decorative product

(76) Inventor: Joseph W. Coburn JR., Jackson, NJ (US)

Correspondence Address: R. GALE RHODES, JR., Suite 100, 595 Shrewsbury Avenue, Shrewsbury, NJ, 07702, US

(21) Appl. No.: 10/757,208

(22) Filed: Jan. 14, 2004

Related U.S. Application Data
(63) Continuation of application No. 10/175,013, filed on Jun. 19, 2002.

(51) Int. Cl. B32B 3/28

(52) U.S. Cl. 428/167

(57) ABSTRACT

An optically decorative product including a layer of transparent polymeric material having opposed surfaces, one of the opposed surfaces provided with a plurality of ridges and grooves, a layer of substantially transparent color effect producing material mounted to one of the opposed surfaces, the layer of transparent polymeric material and the layer of substantially transparent color effect producing material combining to produce in the presence of light a color effect image such that the material has an appearance other than that of a surface of the material and the image being other than coincident with the surfaces, and a layer of product mounting adhesive applied to the opposed surface of the material to which the layer of substantially transparent color effect producing material is not mounted.

### CROSS-REFERENCE TO RELATED APPLICATION

This application is a continuation of pending application Ser. No. 10/175,013, filed Jun. 19, 2002, entitled OPTICALLY DECORATIVE MATERIAL, Joseph W. Coburn, Jr., inventor.

### BACKGROUND OF THE INVENTION

This invention relates to an optically decorative product which may be used, by way of example and not by way of limitation, in the automotive after market as edge trim or molding or side body molding and which may also be used, by way of further example and not by way of limitation, in furniture applications such as edge molding or trim.

The optically decorative product of this invention is of the same general type as the Optically Decorative Web disclosed in U.S. Pat. No. 3,908,056, issued Sep. 23, 1975, Raymond H. Anderson, Inventor.

### SUMMARY OF THE INVENTION

This invention relates to an optically decorative product including a layer of transparent polymeric material having opposed surfaces, one of the opposed surfaces provided with a plurality of ridges and grooves, a layer of substantially transparent color effect producing material mounted to one of the opposed surfaces; the layer of transparent polymeric material and the layer of substantially transparent color effect producing material producing in the presence of light a color effect image such that the material has an appearance other than that of a surface of the material and the image being other than coincident with the surfaces; and a layer of product mounting adhesive applied to the opposed surface of the material to which the layer of substantially transparent color effect producing material is not mounted.

### DESCRIPTION OF THE DRAWINGS

FIG. 1 is a fragmentary perspective view of a section of an optically decorative product according to the present invention;

FIG. 2 is a fragmentary perspective view of a section of an alternate embodiment of the optically decorative product of the present invention; and

FIG. 3 is a fragmentary perspective view of a section of a further alternate embodiment of the optically decorative product of the present invention.

### DESCRIPTION OF THE PREFERRED EMBODIMENTS

Referring to FIG. 1, a first embodiment of the optically decorative product according to the present invention is illustrated and indicated by general numerical designation 10. Optically decorative product 10 may include a layer of transparent polymeric material 12 having opposed surfaces. As viewed in FIG. 1, the upper opposed surface is smooth and the lower opposed surface is provided with a plurality of ridges and grooves indicated by general numerical designation 14. The above-referenced U.S. Pat. No. 3,908,056 is hereby incorporated herein by reference as if fully reproduced herein. Accordingly, it will be understood, that such plurality of ridges and grooves 14 may be any one of the various pluralities of ridges and grooves disclosed in the incorporated patent and that such plurality of ridges and grooves 14 will perform the same functions as the various pluralities of ridges and grooves disclosed in the incorporated patent. Referring further to FIG. 1, the optically decorative product 10 may include a layer of substantially transparent color effect producing material 16 mounted to the upper smooth opposed surface of the polymeric material 12 by a layer of substantially transparent adhesive 18. The plurality of ridges and grooves 14 may be provided with a layer of reflective metallic material 20 such as by sputtering or vapor deposition and a layer of product mounting adhesive 22 may be applied to the plurality of ridges and grooves, or to the layer of metallic reflecting material 20 if applied, for mounting the optically decorative product 10 to an article such as described above and such as described in the incorporated patent. A protective layer or release liner 24 may be applied to the layer of product mounting adhesive 22.

It will be understand in accordance with the teachings of the present invention that the layer of transparent polymeric material 12, FIG. 1, provided with a plurality of ridges and grooves 14, and the layer of substantially transparent color effect producing material 16, combined to produce, in the presence of light, a color effect image such that the material 12 has an appearance other than that of a surface of the material 12 and that such image is other than coincident with the opposed surfaces of such material 12.

It will be further understood, in according with the teachings of the present invention, that the layer of substantially transparent color effect producing material 16, FIG. 1, may be a layer of substantially transparent colored polymeric material such as polyvinylchloride, polyester or polycarbonate and that the layer of substantially transparent adhesive 18 may be a layer of substantially transparent colored adhesive which may be of the same color as the color of the layer of substantially transparent colored polymeric material. It will be understood that the color of such layer of substantially transparent colored polymeric material upon being, for example, red, will produce a red color effect image of the type noted above.

Still further, in accordance with the teachings of the present invention, the layer of substantially transparent color effect producing material 16 of FIG. 1 may be a layer of substantially transparent iridescent material whereby the above-noted color effect image produced will be that of an iridescent color effect image. Such substantially transparent iridescent material may be, by way of example, a layer of film of substantially transparent iridescent film available from the 3M Corporation under the name 3M Gradient Film, a layer or film of substantially transparent iridescent material available of Englehard Industries under the name Mearl Iridescent Film, and the like.

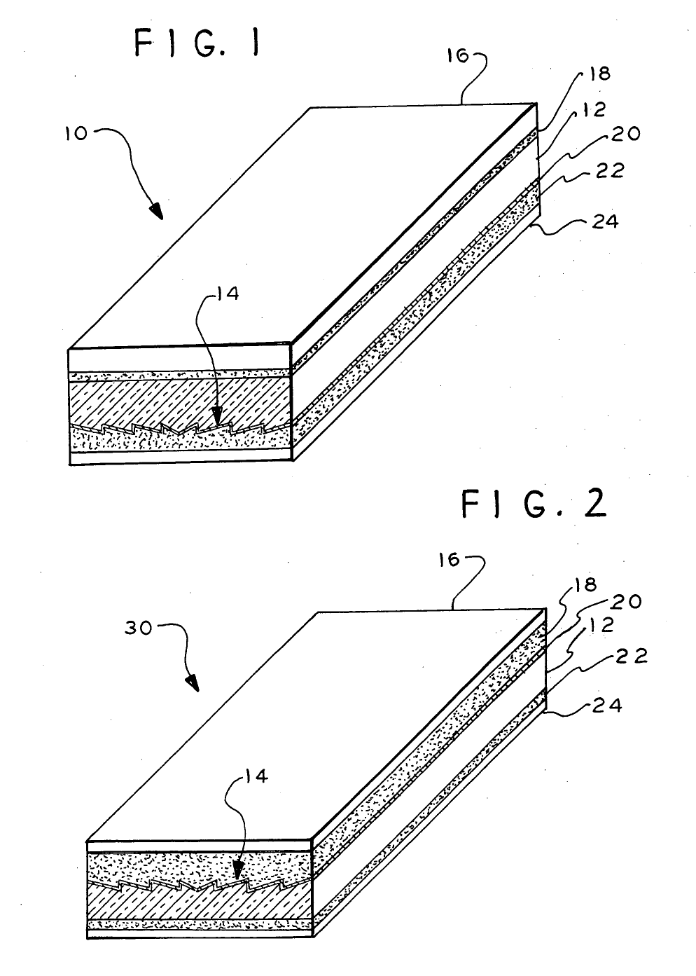

Referring now to FIG. 2, a further embodiment of the optically decorative product of the present invention is shown and indicated by general numerical designation 30. In this embodiment, it will be noted in comparison to FIG. 1, that the layer of transparent polymeric material 12 is reversed in orientation, or upside down with respect to, the layer 12 of FIG. 1. Further, in the embodiment 30 of FIG. 2, the layer of substantially transparent color effect producing material 16 is mounted to the opposed surface of the material 12 provided with the plurality of ridges and grooves 14 by the layer of substantially transparent adhesive 18. The plurality of ridges and grooves 14 may be provided with the layer of reflective metallic material 20. The smooth opposed surface of the layer of transparent polymeric material 12 has the layer of product mounting adhesive 22 applied thereto and the optically decorative product 30 may also include the layer of protective material or release liner 24. The optically decorative product 30 of FIG. 2 functions in the same manner to provide the color effect image as does the optically decorative product 10 shown in FIG. 10 and described above.

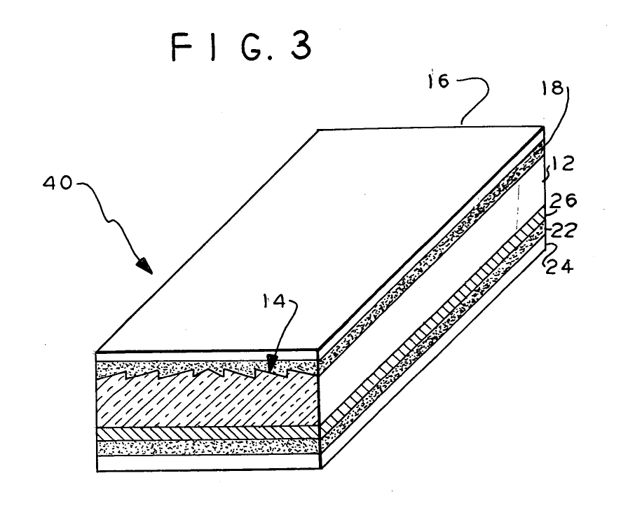

A still further embodiment of the optically decorative product of the present invention is shown in FIG. 3 and indicated by general numerical designation 40. Optically decorative product 40 is substantially the same as optically decorative product 30 of FIG. 2 and hence corresponding structure elements are given the same numerical designations and perform the same functions. In the optically decorative product 40 of FIG. 3, the plurality of ridges and grooves 40 are not provided with a layer of reflective metallic material and instead the bottom or opposed smooth surface of the layer of transparent polymeric material 12 is provided with a layer 26 of reflective metallic material. As will be noted from FIG. 3, the layer of product mounting adhesive is applied to the layer of reflective metallic material 22 and the protective layer or release liner 24 may also be incorporated. The function of the optically decorative product 40 of FIG. 3 is the same, at least substantially the same, as the function of the optically decorative product 30 of FIG. 2 in producing the above-noted color effect image.

Referring again to the invention embodiments of FIGS. 1-3, it will be noted that as shown in these FIGS. in the present invention the layer of substantially transparent color effect producing material 16 is an outer or external layer of substantially transparent color effect producing material so that in the presence of light such outer or external color effect producing material 16 will combine with the layer of transparent polymeric material 12 to produce the color effect image such that the layer of transparent polymeric material 12 has an appearance other than a surface of such layer of transparent polymeric material 12 and with such color effect image being other than coincident with the opposed surfaces of such layer of transparent polymeric material.

It will be further understood that the layer of transparent polymeric material 12 may be a layer or film of polyvinylchloride, or polyester, or polycarbonate, or the like.

Still further, it will be understood, that the various above-described optically decorative product embodiments, as shown in FIGS. 1-3, may be manufactured by suitable manufacturing methods known to the art for producing laminates of the layers of material described above and incorporated into these embodiments.

It will be understood that many variations and modifications may be made in the present invention without departing from the spirit and scope thereof.

What is claimed is:

1. An optically decorative product, comprising:
a layer of transparent polymeric material having opposed surfaces, one of said opposed surfaces provided with a plurality of parallel ridges and grooves, said ridges being parallel ridges formed by facets defining a convex surface joined by surfaces forming steps connecting the adjacent facets;
an outer layer of substantially transparent color effect producing material mounted to one of said opposed surfaces;
said layer of transparent polymeric material and said layer of substantially transparent color effect producing material combining to produce in the presence of light a color effect image such that said layer of transparent polymeric material has an appearance other than that of a surface of said layer of transparent polymeric material and said image being other than coincident with said opposed surfaces; and
a layer of product mounting adhesive applied to the opposed surface of said material to which said layer of substantially transparent color effect producing material is not mounted.

2. The optically decorative product according to claim 1 wherein said layer of substantially transparent color effect producing material is a layer of substantially transparent colored polymeric material.

3. The optically decorative product according to claim 2 wherein said layer of substantially transparent colored polymeric material is mounted to said one of said opposed surfaces by a layer of substantially transparent adhesive.

4. The optically decorative product according to claim 3 wherein said layer of substantially transparent adhesive is a layer of substantially transparent colored adhesive.

5. The optically decorative product according to claim 4 wherein said layer of substantially transparent colored adhesive is a layer of substantially clear colored adhesive of the same color as said layer of substantially transparent colored polymeric material.

6. The optically decorative product according to claim 1 wherein said layer of substantially transparent color effect producing material is a layer of substantially transparent iridescent material, and wherein said layer of transparent polymeric material and said layer of substantially transparent iridescent material produce in the presence of light a color effect image which is an iridescent color effect image.

7. The optically decorative product according to claim 6 wherein said layer of substantially transparent iridescent material is mounted to said one of said opposed surfaces by a layer of substantially transparent adhesive.

8. The optically decorative product according to claim 1 wherein said ridges and grooves are coated with a layer of reflective metallic material.

9. The optically decorative product according to claim 1 wherein said layer of substantially transparent color effect producing material is mounted to said opposed surface provided with said plurality of ridges and grooves by a layer of substantially transparent adhesive.

10. The optically decorative product according to claim 1 wherein said layer of substantially transparent color effect producing material is mounted to said opposed surface provided with said plurality of ridges and grooves by a layer of substantially transparent adhesive, wherein the other of said opposed surfaces is a smooth surface and wherein said layer of product mounting adhesive is applied to said smooth opposed surface.

11. The optically decorative product according to claim 1 wherein said layer of substantially transparent color effect producing material is mounted to said opposed surface provided with said plurality of ridges and grooves by a layer of substantially transparent adhesive, wherein the other of said opposed surfaces is smooth surface and wherein said optically decorative product further comprises a layer of reflective metallic material applied to said smooth surface and wherein said layer of product mounting adhesive is applied to said layer of reflective metallic material.

12. The optically decorative product according to claim 1 wherein the other of said opposed surfaces is a smooth surface and wherein said layer of substantially transparent color effect producing material is applied to said smooth surface by a layer of substantially transparent adhesive, and wherein said layer of product mounting adhesive is applied to said one of said opposed surfaces.
